(19) United States
(12) Patent Application Publication
(10) Pub. No.: US 2015/0177668 A1
(43) Pub. Date: Jun. 25, 2015

(54) PRINTING SYSTEM, PRINTING METHOD AND NON-TRANSITORY RECORDING MEDIUM

(71) Applicant: CASIO COMPUTER CO., LTD., Tokyo (JP)

(72) Inventors: Toshihiko NUMAZU, Sayama-shi (JP); Toshio NAGASAKA, Iruma-shi (JP); Toshiaki YAJIMA, Iruma-shi (JP)

(73) Assignee: CASIO COMPUTER CO., LTD., Tokyo (JP)

(21) Appl. No.: 14/562,131

(22) Filed: Dec. 5, 2014

(30) Foreign Application Priority Data
Dec. 20, 2013 (JP) 2013-264239

(51) Int. Cl. G03G 15/00

(52) U.S. Cl. CPC G03G 15/6529

(57) ABSTRACT

A printing system comprising:
a controller that generates image data and controls printing;
a first paper supplier that unwinds and supplies a printing medium wound around a winding shaft;
a first image-forming unit that forms a first image based on image data, on the printing medium unwound and supplied by the first paper supplier;
a winder that winds the printing medium on which the first image-forming unit formed the first image around a winding shaft in order from a beginning edge to a ending edge of the printing medium;
a second paper supplier that unwinds and supplies the printing medium the winder wound around the winding shaft, in order from the ending edge to the beginning edge of the printing medium; and
a second image-forming unit that forms a second image based on image data in which top and bottom have been reversed and left and right have been reversed in the area where the first image was formed on the printing medium unwound and supplied by the second paper supplier.

### CROSS-REFERENCE TO RELATED APPLICATION

This application claims the benefit of Japanese Patent Application No. 2013-264239, filed on Dec. 20, 2013, the entire disclosure of which is incorporated by reference herein.

### FIELD

This application relates generally to a printing system, printing method and non-transitory recording medium.

### BACKGROUND

As a printing medium for an image-forming apparatus such as a printer, a copier, a facsimile machine and/or the like to form images, a printing medium (hereafter called roll paper) wound in a roll shape, such as paper, film and/or the like, exists. The roll paper can be stored without needing to be cut by large equipment. Consequently, the roll paper is widely used when accomplishing large-area image formation without a break, for example in a label printer continuously printing multiple labels or seals.

Accompanying increases in printing quality with digital printing in recent years, even with large-area printing using roll paper, quality close to that of printed materials such as flexography, gravure printing, offset printing and/or the like is needed. Consequently, being able to print with white, transparent and other colors on the roll paper is demanded, in addition to the four colors of YMCK (yellow (Y), magenta (M), cyan (C) and black (K)) that can be used with color printers under a four-way tandem method by means of typical electronic photograph formats.

Printers corresponding to five-way or more tandem methods are known as a method of adding white and/or other colors to the four colors of YMCK in color printers (for example, see Unexamined Japanese Patent Application Kokai Publication No. 2011-174984). However, methods using printers of five-way or more tandem methods require preparation of specialty printers, causing the apparatus to become large and costs to become high.

In addition, a method of creating the K color (black) out of YMCK by superimposing the three colors of YMC (process black) and adding another color in place of the K color is known. In this case, a lowering of quality is caused compared to cases using only the one color K due to factors such as misalignment occurring when overlapping multiple colors.

Furthermore, when multiple colors of developing agent are layered at once on a printing medium and the thickness of the developing agent increases, for example with five or six colors, a considerable burden is placed on the fuser apparatus that fuses the developing agent, leading to deterioration of fusing precision. In order to avoid this, a method has been conceived wherein fusing is conducted by lowering the density of the developing agent per color, for example, or lowering the fusing speed for the area where many colors of developing agent are layered, but this leads to a drop in printing quality and printing speed.

### SUMMARY

The printing system according to the present disclosure comprises:

a controller that generates image data and controls printing;

a first paper supplier that unwinds and supplies a printing medium wound around a winding shaft;

a first image-forming unit that forms a first image based on image data, on the printing medium unwound and supplied by the first paper supplier;

a winder that winds the printing medium on which the first image-forming unit formed the first image around a winding shaft in order from a beginning edge to a ending edge of the printing medium;

a second paper supplier that unwinds and supplies the printing medium the winder wound around the winding shaft, in order from the ending edge to the beginning edge of the printing medium; and

a second image-forming unit that forms a second image based on image data in which top and bottom have been reversed and left and right have been reversed in the area where the first image was formed on the printing medium unwound and supplied by the second paper supplier.

In addition, in order to achieve the above objective, the printing method according to the present disclosure includes:

unwinding and supplying a printing medium wound around a winding shaft;

forming a first image on the supplied printing medium based on image data;

winding the printing medium on which the image was formed around a winding shaft in order from a beginning edge to a ending edge of the printing medium;

unwinding and supplying the printing medium wound around the winding shaft in order from the ending edge to the beginning edge of the printing medium; and

forming a second image in the area on which the first image was formed on the printing medium unwound and supplied, based on image data in which top and bottom have been reversed and left and right have been reversed.

In addition, in order to achieve the above objective, the non-transitory computer-readable recording medium according to the present disclosure has stored thereon a program executable by a computer of a device, the program controlling the computer to perform functions comprising:

unwinding a printing medium wound around a winding shaft;

forming a first image on the unwound printing medium based on image data;

winding the printing medium on which the image was formed around a winding shaft in order from a beginning edge to a ending edge of the printing medium;

unwinding the printing medium wound around the winding shaft in order from the ending edge to the beginning edge of the printing medium; and

forming a second image in the area on which the first image was formed on the printing medium unwound and supplied, based on image data in which top and bottom have been reversed and left and right have been reversed.

### BRIEF DESCRIPTION OF THE DRAWINGS

A more complete understanding of this application can be obtained when the following detailed description is considered in conjunction with the following drawings, in which:

FIG. 1 is a drawing showing the composition of a printing system according to a first exemplary embodiment of the present disclosure;

FIG. 2A is a cross-sectional view showing the internal composition of a first image-forming apparatus;

FIG. 2B is a cross-sectional view showing the internal composition of a second image-forming apparatus;

FIG. 3 is a block diagram showing a composition relating to control of the first image-forming apparatus, the second image-forming apparatus and a terminal apparatus;

FIG. 4A is a drawing showing an example of image data of a printing target;

FIG. 4B is a drawing showing an example of normal color image data;

FIG. 4C is a drawing showing an example of reversal data in which the image data of the printing target was reversed;

FIG. 4D is a drawing showing an example of special color image data;

FIG. 5 is a block diagram showing a composition relating to control of two paper supply apparatuses and two winding apparatuses;

FIG. 6 is a drawing showing the state when the roll paper is attached to the holder of a first paper supply apparatus;

FIG. 7A is a drawing showing roll paper supplied from the first paper-supplying apparatus;

FIG. 7B is a drawing showing roll paper after image formation by the first image-forming apparatus;

FIG. 8A and FIG. 8B are both drawings showing the state when the winding apparatus winds the roll paper ejected from the first image-forming apparatus;

FIG. 9A and FIG. 9B are both drawings showing the state when the roll paper wound by the winding apparatus is attached to the holder of the second paper supply apparatus;

FIG. 10A is a drawing showing the roll paper supplied from the second paper supply apparatus;

FIG. 10B is a drawing showing the roll paper after image formation by the second image-forming apparatus;

FIG. 11 is a first flowchart showing the flow of processes executed in the printing system according to the first exemplary embodiment;

FIG. 12A and FIG. 12B are a second flowchart showing the flow of processes executed in the printing system according to the first exemplary embodiment;

FIG. 13 is a drawing showing the composition of a printing system according to a second exemplary embodiment of the present disclosure;

FIG. 14 is a drawing showing the state when the second image formation is accomplished in the printing system according to the second exemplary embodiment;

FIG. 15 is a drawing showing the composition of a printing system according to a third exemplary embodiment of the present disclosure; and

FIG. 16 is a drawing showing the state when the second image formation is accomplished in the printing system according to the third exemplary embodiment.

### DETAILED DESCRIPTION

Below, the exemplary embodiments of the present disclosure are described with reference to the drawings. Parts that are the same or corresponding in the drawings are labeled with the same reference symbols.

### First Exemplary Embodiment

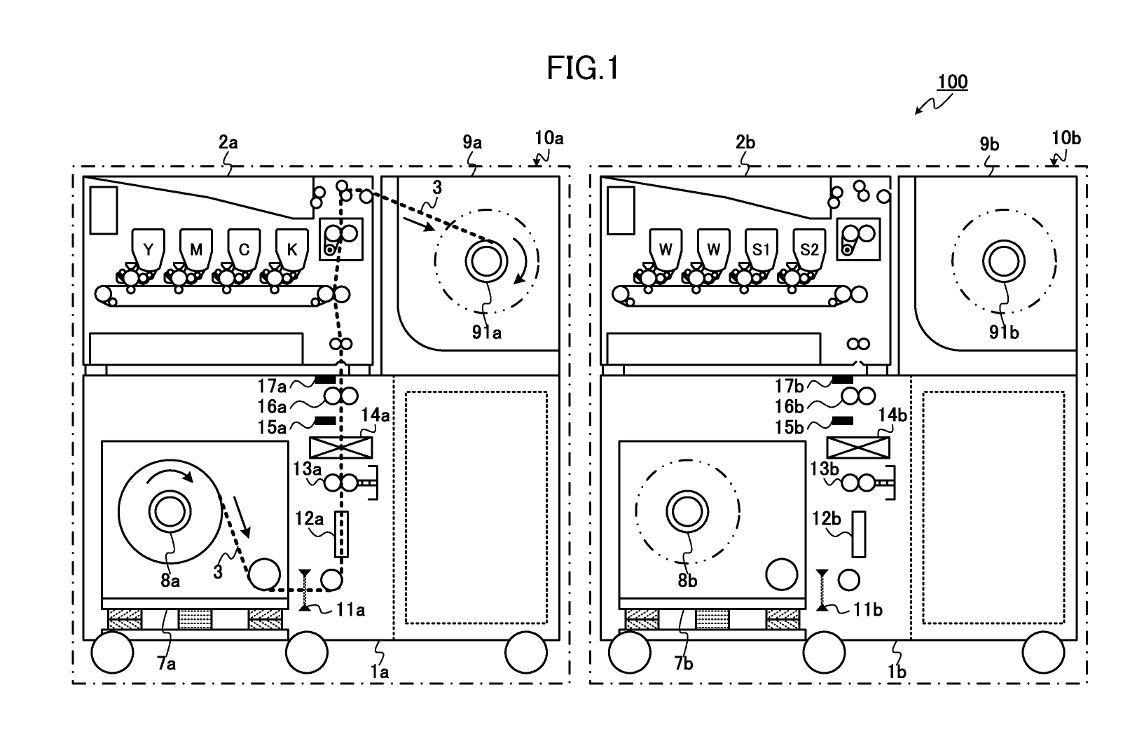

FIG. 1 shows the composition of a printing system according to a first exemplary embodiment. The printing system 100 comprises a normal color printing system 10a comprising a paper supply apparatus 1a (first paper supplier), an image-forming apparatus 2a (first image-forming unit) and a winding apparatus 9a (first winder), and a special color printing system 10b comprising a paper supply apparatus 1b (second paper supplier), an image-forming apparatus 2b (second image-forming unit) and a winding apparatus 9b (second winder). The printing system 100 prints in multiple colors on roll paper 3 that is a printing medium, using the normal color printing system 10a and the special color printing system 10b.

In the first exemplary embodiment, the first and second paper suppliers, the first and second image-forming units and the first and second winders are described on the condition of being separate units (that is to say, the first and second of each unit are physically separate). However, this is intended to be illustrative and not limiting, for it would be fine for the first and second paper suppliers, the first and second image-forming units and the first and second winders to be comprised as the same unit (that is to say, the first and second of each unit are physically the same), as in the below-described second and third exemplary embodiments.

The paper supply apparatus 1a provided in the normal color printing system 10a supplies the roll paper 3 as a printing medium for image formation to the image-forming apparatus 2a. The paper supply apparatus 1a continuously unwinds the roll paper 3 in which paper is wound in a rolled sate around a prescribed winding core (paper tube) and conveys the roll paper 3 to the image-forming apparatus 2a along a prescribed conveyance path. Specifically, the paper supply apparatus 1a comprises a slide table 7a, a holder 8a, an incline detection sensor 11a, a side guide 12a, a paired conveyor roller 13a, an auto cutter 14a, a mark sensor 15a, a paired feed roller 16a and a feed sensor 17a.

The holder 8a functions as a first holder and holds the roll paper 3 prior to an image being formed by the image-forming apparatus 2a. The holder 8a comprises a rotatable rotation shaft that holds the roll paper 3 via the winding core at the winding center of the roll paper 3, and a support table that supports the rotation shaft, and supports the roll paper 3 so that rotation is possible.

An unrepresented motor for causing the rotation shaft to rotate is mounted in the holder 8a. The holder 8a functions as an unwinder that unwinds the roll paper 3 held, by causing the rotation shaft to rotate an indicated number of rotations per unit time (the number of times rotated per unit time) under driving by the motor.

In addition, an unrepresented powder brake (brake unit) is attached to the rotation shaft of the holder 8a. The powder brake applies a brake to rotation of the rotation shaft so that the tension applied to the roll paper conveyed by being unwound from the holder 8a is kept constant. Through the function of the powder brake, the roll paper 3 unwound from the holder 8a is conveyed stably without slackening. The rotation speed of the rotation shaft is set at a speed at which the roll paper 3 does not slacken.

The slide table 7a is provided with a slide bearing on both sides and causes the holder 8a to slide in the direction of the rotation shaft (the sideways direction of the roll paper 3). When the slide table 7a detects an incline of the roll paper 3 conveyed inside the paper supply apparatus 1a, drive force is obtained through an actuator and causes the holder 8a to move in a direction to negate the detected incline. An incline controller comprises the incline detection sensor 11a, the slide table 7a, the actuator and the controller 82a controlling such.

The incline detection sensor 11a detects inclines of the roll paper 3 conveyed inside the paper supply apparatus 1a. Specifically, the incline detection sensor 11a comprises multiple sets of light-emitting elements and light-receiving elements faced each other across the end of the roll paper 3 in the sideways direction. The incline detection sensor 11a determines the position deviation of the end of the roll paper 3 in the sideways direction without contacting the roll paper 3, by determining whether or not light emitted from the light-emitting elements is received by the light-receiving elements without being blocked, for each of the multiple sets.

The paired conveyor roller 13a sandwiches and conveys the roll paper 3 unwound from the holder 8a and conveyed via the following roller and the side guide 12a, and supplies the roll paper 3 to the paired feed roller 16a. The paired feed roller 16a sandwiches and conveys the roll paper 3 supplied from the paired conveyor roller 13a, and supplies the roll paper 3 to the image-forming apparatus 2a.

The auto cutter 14a cuts the roll paper 3 as necessary. The auto cutter 14a cuts the ending edge (back edge) of the roll paper 3 for example when roll paper 3 of a length necessary for image formation in the image-forming apparatus 2a has finished being conveyed.

The mark sensor 15a detects an original mark recorded on the surface of the roll paper and used by the image-forming apparatus 2a as a position reference for forming images. Specifics of the original mark are described below.

The feed sensor 17a detects the beginning edge (front edge) of the roll paper 3 fed to the image-forming apparatus 2a from the paired feed roller 16a. Specifically, the feed sensor 17a comprises a light-emitting element and a light-receiving element, and determines that the beginning edge of the roll paper 3 has been detected when light emitted from the light-emitting element is blocked by the beginning edge of the roll paper 3 and is not detected by the light-receiving element. When the feed sensor 17a detects the beginning edge of the roll paper 3, the image-forming apparatus 2a starts driving of the various types of paired rollers and causes the roll paper 3 fed to the inside to be conveyed.

The region indicated by the dotted line on the right side of the paper supply apparatus 1a is used to house consumables such as roll paper, toner and/or the like.

The paper supply apparatus 1b with which the special color printing system 10b is equipped supplies roll paper 3 to the image-forming apparatus 2b as a recording medium for image formation. Specifically, the paper supply apparatus 1b comprises a slide table 7b, a holder 8b, an incline detection sensor 11b, a slide guide 12b, a paired conveyor roller 13b, an auto cutter 14b, a mark sensor 15b, a paired feed roller 16b and a feed sensor 17b. The holder 8b functions as a second holder and holds the roll paper 3 after an image is formed by the first image-forming apparatus 2a and the paper is wound by a winding apparatus 9a (winder). The paper supply apparatus 1b has the same composition as the above-described paper supply apparatus 1a, so detailed explanation of the various constituent elements comprising the paper supply apparatus 1b is omitted.

The winding apparatus 9a comprising the normal color printing system 10a functions as a first winder (first rewinder), and winds and holds around the winding shaft 91a the roll paper 3 ejected from the image-forming apparatus 2a. An unrepresented powder brake (slip unit) is attached to the rotation shaft of the winding shaft 91a. The powder brake applies slipping to rotation of the rotation shaft of the winding shaft 91a so that the tension applied to the roll paper 3 conveyed from the paired paper eject roller 44 is kept constant. Through the function of the powder brake, the roll paper 3 conveyed from the paired paper eject roller 44 is wound stably on the winding shaft 91a.

Similarly, the winding apparatus 9b comprising the normal color printing system 10b functions as a second winder (second rewinder), and winds and holds around the winding shaft 91b the roll paper 3 ejected from the image-forming apparatus 2b.

The image-forming apparatus 2a with which the normal color printing system 10a is equipped is placed on top of the paper supply apparatus 1a and functions as a first image-forming unit that forms a first image of developing agent in the four colors of YMCK (yellow (Y), magenta (M), cyan (C) and black (K)) based on image data of the printing target, and transfers the first developing agent image to the roll paper 3 supplied from the paper supply apparatus 1a. The image-forming apparatus 2b with which the special color printing system 10b is equipped is placed on top of the paper supply apparatus 1b and functions as a second image-forming unit that forms a second image through developing agent of special colors not included in the four colors of YMCK and transfers the second developing agent image to the roll paper 3 supplied from the paper supply apparatus 1b.

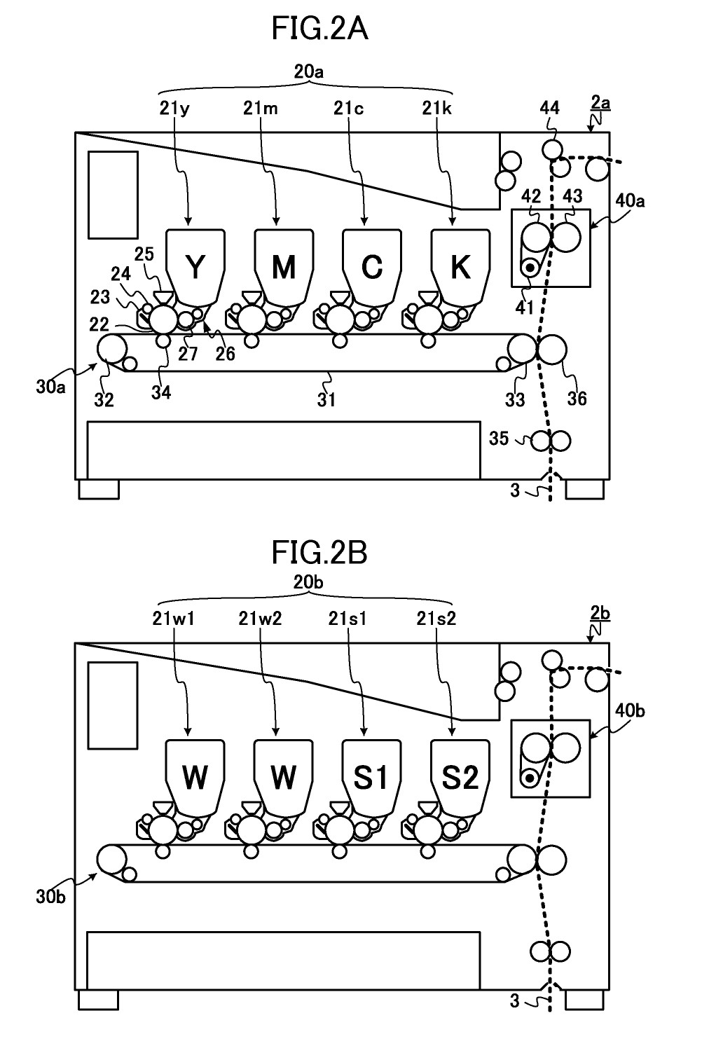

The internal compositions of the image-forming apparatus 2a and the image-forming apparatus 2b is described with reference to FIG. 2A and FIG. 2B. Below, the image-forming apparatus 2a and the image-forming apparatus 2b are described by taking as an example a secondary transfer-type tandem color printer of electronic photo format. In addition, the explanation below takes as an example a case in which toner is used as the developing agent.

As shown in FIG. 2A, the image-forming apparatus 2a comprises an image-forming unit 20a, an intermediate transfer belt unit 30a and a fuser apparatus 40a.

The image-forming apparatus 20a is provided with a composition in which four image-forming parts 21y, 21m, 21c and 21k are arranged linearly. The image-forming parts 21y, 21m and 21c form color images through color toner of yellow (Y), magenta (M) and cyan (C), which are the three primary colors of subtractive mixture colors. On the other hand, the image-forming part 21k forms monochrome images of black (K) toner used primarily in text and dark parts of images, and or the like.

Each of the image-forming parts 21 comprises a photosensitive drum 22 at the bottom. This photosensitive drum 22 comprises an organic photoconductive material, for example, on a cylinder surface. Near the photosensitive drum 22, a cleaner 23, a charged roller 24, an optical writing head 25 and a developing roller 27 of a developer 26 are positioned as though surrounding the cylinder surface.

The developer 26 stores toner of yellow (Y), magenta (M), cyan (C) and black (K) in a toner container positioned on top, in the center is provided with a toner replenishing mechanism to the bottom, and on the bottom is provided with the developing roller 27. The developer 26 is further equipped with a toner stirrer inside, a toner supply roller for supplying toner to the developing roller 27, and a doctor blade for regulating the toner layer on the developing roller 27 to a constant thickness.

Reference symbols are appended to only the composition of the image-forming part 21y for yellow (Y) in FIG. 2A, but each of the image-forming parts 21 have the same composition excepting for the color of the toner stored in the toner container.

The intermedia transfer belt unit 30a comprises an endless transfer belt 31 extending in a flat loop shape substantially in the center of the image-forming apparatus 2a; a driving roller 32 over which the transfer belt 31 is passed, the driving roller 32 causing the transfer belt 31 to circulate and move in a counter-clockwise direction; and a following roller 33. The transfer belt 31 conveys the toner image transferred (primary transfer) directly to the belt surface to the transfer position so that toner image on the belt surface can transfer (secondary transfer) to the roll paper 3.

The intermediate transfer belt unit 30a is provided with four primary transfer rollers 34 corresponding to the four image-forming parts 21y, 21m, 21c, 21k, within the loop of the transfer belt 31. The primary transfer rollers 34 comprise conductive foam sponges for pressing against the bottom cylinder surface of the photosensitive drum 22 via the transfer belt 31, and rotate with a specified rotation period and cause the transfer belt 31 to contact the photosensitive drum 22 and separate from the photosensitive drum 22.

A paired standby conveyor roller 35 receives the roll paper 3 supplied from the paper supply apparatus 1 via a feed opening for expansion paper supply, and conveys the roll paper 3 received to a secondary transfer roller 36. The secondary transfer roller 36 is positioned so as to press against the following roller 33 via the transfer belt 31, and forms a secondary transfer unit that makes a secondary transfer to the roll paper 3 of the toner image transferred to the belt surface of the transfer belt 31.

The fuser apparatus 40a comprises a heater 41 built-in heating roller 42, and a pressure roller 43 that presses against the heating roller 42. The fuser apparatus 40a heats and presses on, thereby fusing, the unfused toner on the roll paper 3 after secondary transfer.

In addition, on the downstream side of the fuser apparatus 40a, a paired paper eject roller 44 is positioned for ejecting the roll paper 3 from the image-forming apparatus 2a after toner fusing. The roll paper 3 that has passed through the paired paper eject roller 44 is ejected from the image-forming apparatus 2a and is wound by the winding apparatus 9a.

As shown in FIG. 2B, the image-forming apparatus 2b comprises an image-forming unit 20b, an intermediate transfer belt unit 30b and a fuser apparatus 40b. The image-forming apparatus 2b has the same composition as the image-forming apparatus 2a with the exception of the color of toner stored in the four image-forming parts 21w1, 21w2, 21s1 and 21s2 in the image-forming unit 20b. Consequently, detailed description of the other constituent elements comprising the image-forming apparatus 2b is omitted.

The image-forming unit 20b is provided with a composition in which four image-forming parts 21w1, 21w2, 21s1 and 21s2 that form images using toner of colors not including the four colors of YMCK are arranged linearly. By using toner of special colors, it is possible to express colors that cannot be expressed by the four colors of YMCK and it is possible to increase the quality of printed materials.

Specifically, the image-forming parts 21w1 and 21w2 both comprise toner containers containing white (W) toner and form images with white toner. That is to say, the image-forming apparatus 2b forms white toner images respectively with the two image-forming parts 21w1 and 21w2, and forms white images by superimposing the two white toner images on the transfer belt 31. By superimposing two white toner images, it is possible to express images with white of sufficient depth without the base colors becoming transparent, even when for example images are formed in areas where base colors such as black or red are deep.

On the other hand, the image-forming parts 21s1 and 21s2 respectively comprise toner containers containing toner of special colors other than white and form images through the special-colored toner. As special colors other than white, gold, silver, transparent (invisible) colors that emit light when irradiated with ultraviolet rays and special colors for providing fluorescent light or gloss, and/or the like, can be cited. The image-forming parts 21s1 and 21s2 form images through toner of at least one or more of these colors.

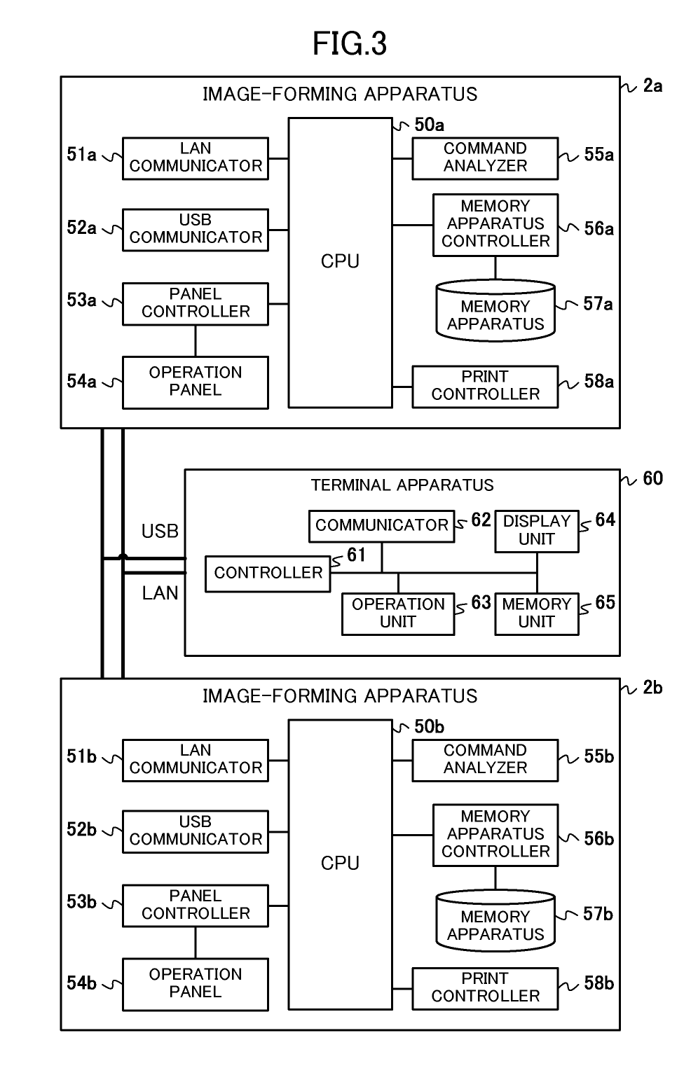

Next, referring to FIG. 3, the composition relating to control of the image-forming apparatus 2a and the image-forming apparatus 2b is described. The image-forming apparatus 2a and the image-forming apparatus 2b are connected to each other by a terminal apparatus 60 and a network such as a LAN (Local Area Network) and/or the like or a USB (Universal Serial Bus).

The image-forming apparatus 2a comprises a CPU (Central Processing Unit) 50a, a LAN communicator 51a, a USB communicator 52a, a panel controller 53a, an operation panel 54a, a command analyzer 55a, a memory apparatus controller 56a, a memory apparatus 57a and a print controller 58a.

The CPU 50a is connected to the various components of the image-forming apparatus 2a via a system bus that is a transmission route for transmitting commands and data, and controls the actions of the various components of the image-forming apparatus 2a. The CPU 50a, while using an unrepresented ROM (Read Only Memory) and RAM (Random Access Memory) as work memories, reads out various types of programs such as system software and/or the like stored in the ROM and the memory apparatus 57a and executes appropriately.

The LAN communicator 51a and the USB communicator 52a communicate with external equipment including the terminal apparatus 60, the paper supply apparatus 1a and the winding apparatus 9a via the LAN and USB, respectively.

The panel controller 53a is connected to the operation panel 54a comprising for example a display panel such as an LCD (Liquid Crystal Display) and/or the like and an input apparatus including various types of operation buttons. The panel controller 53a, under control of the CPU 50a, displays images and text and/or the like on the operation panel 54a and receives operations from a user input into the operation panel 54a.

The command analyzer 55a, under control of the CPU 50a, analyzes commands included in print data sent from the terminal apparatus 60 and converts the print data into bitmap image data. The command analyzer 55a develops the converted bitmap image data in a memory area corresponding to frame memory for each color of toner with which the image-forming apparatus 2a is equipped. The image data developed in the frame memory is output to the print controller 58a.

The memory apparatus 57a is non-volatile memory such as an EEPROM (Electrically Erasable Programmable ROM), HDD (Hard Disk Drive) and/or the like. The memory apparatus controller 56a, under control of the CPU 50a, controls writing of data to the memory apparatus 57a and reading of data stored in the memory apparatus 57a.

The print controller 58a, under control of the CPU 50a, controls the printing mechanism including the image-forming unit 20a, the intermediate transfer belt unit 30a and the fuser apparatus 40a, and accomplishes a printing process in accordance with image data generated by the command analyzer 55a.

The image-forming apparatus 2b comprises a CPU 50b, a LAN communicator 51b, a USB communicator 52b, a panel controller 53b, an operation panel 54b, a command analyzer 55b, a memory apparatus controller 56b, a memory apparatus 57b and a print controller 58b. The image-forming apparatus 2b has a composition relating to control the same as the image-forming apparatus 2a, so detailed description is omitted.

The terminal apparatus 60 is for example an information processing apparatus such as a PC (Personal Computer) and/or the like, and is connected to the two image-forming apparatuses 2a and 2b via the LAN and the USB. The terminal apparatus 60 comprises a controller 61, a communicator 62, an operation unit 63, a display unit 64 and a memory unit 65.

The controller 61 comprises for example a CPU and RAM and/or the like that functions as a main memory of the CPU. The controller 61 is connected to each component of the terminal apparatus 60 via a system bus that is a transmission route for transmitting commands and data, and controls the terminal apparatus 60 as a whole.

The communicator 62, under control of the controller 61, communicates with the two image-forming apparatuses 2a and 2b via the USB or the LAN.

The operation unit 63 comprises an input apparatus such as a mouse, keyboard and/or the like. The operation unit 63 receives operations from a user. For example, the operation unit 63 supplies to the controller 61 a signal for setting print conditions or a signal for executing printing.

The display unit 64 comprises for example a display device such as a CRT (Cathode Ray Tube), an LCD and/or the like. The display unit 64 displays on a screen images based on image data supplied from the controller 61.

Here, the display colors of the printing image displayed on the display unit 64 are controlled by the controller 61, and the controller displays not only are approximate colors based on the colors of the actual developing agent but also completely different alternate colors. For example, by changing the colors of YMCK used in the first image temporarily to a gray-scale display and displaying colors used in the second image with approximate colors, it becomes easier to identify the first image and the second image.

The memory unit 65 comprises for example a memory apparatus such as an HDD, ROM, flash memory and/or the like. The memory unit 65 stores programs and data the controller 61 uses for executing various types of processes, including printer drivers for printing in multiple colors using the two image-forming apparatuses 2a and 2b.

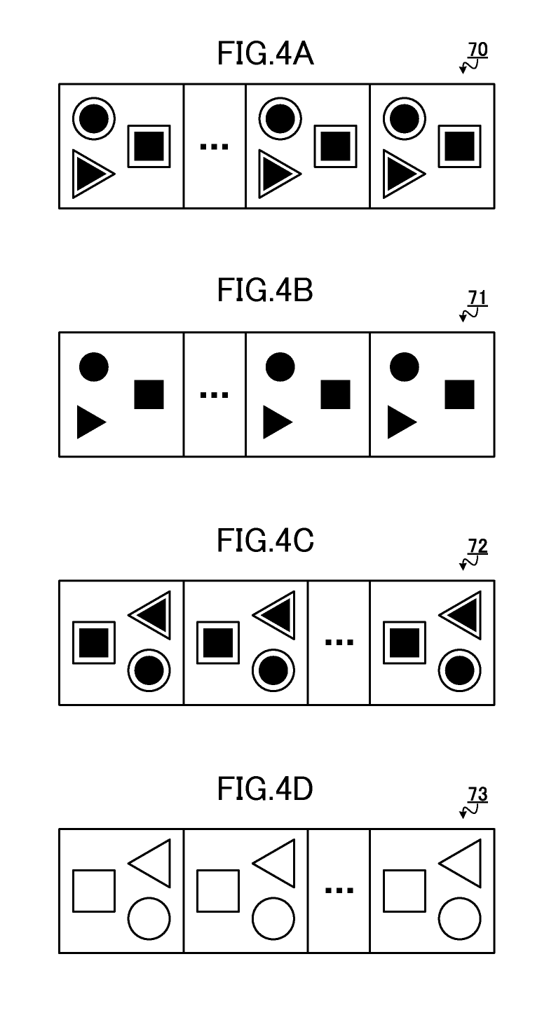

As shown in FIG. 4A as an example, the description is for a case in which image data 70 of multiple labels with the various labels comprising the figures of a square, a circle and a triangle are printed to the roll paper 3 from the terminal apparatus 60 using the printing system 100.

When a user operates the operation unit 63 and executes a print command for image data 70 of a printing target via a prescribed application, the controller 61 generates image data for the normal color printing system 10a and image data for the special color printing system 10b in accordance with the printer driver stored in the memory unit 65.

To explain more specifically, the controller 61 extracts image data that should be output with black (K) toner from the image data 70 of the printing target as image data for the normal color printing system 10a, and generates normal color image data 71 for example as shown in FIG. 4B. When color printing is commanded, the controller 61 further generates the image data that should be output with toner of the colors YMC as image data for the normal color printing system 10a.

In addition, as shown in FIG. 4C, the controller 61 generates reversal data 72 in which the image is reversed top-to-bottom and reversed left-to-right (that is to say, rotated 180 degrees about an axis at the image center) from the image data 70 of the printing target. Furthermore, the controller 61 extracts image data that should be output with special colors of toner from the reversal data 72, as image data for use in the special color printing system 10b, and generates special color image data 73 for example as shown in FIG. 4D. When printing using multiple types of special colors is commanded, the controller 61 generates the commanded types of image data as image data for use in the special color printing system 10b.

At this time, the controller 61 is not limited to generating special color image data 73 from the reversal data 72, for it would be fine to reverse the order of the reversal process and the extraction process. That is to say, it would be fine for the controller 61 to extract image data to be output with special colors of toner from the image data 70 and then to generate the special color image data 73 by reversing the extracted image data top-to-bottom and left-to-right.

The controller 61 sends first print data including the generated normal color image data 71 and print conditions to the image-forming apparatus 2a via the communicator 62. In addition, the controller 61 sends second print data including the generated special color image data 73 and print conditions to the image-forming apparatus 2b via the communicator 62. The print conditions are setting conditions relating to image formation such as resolution and gradation value, and other printing setting conditions such as the size and type of roll paper 3 and printing range.

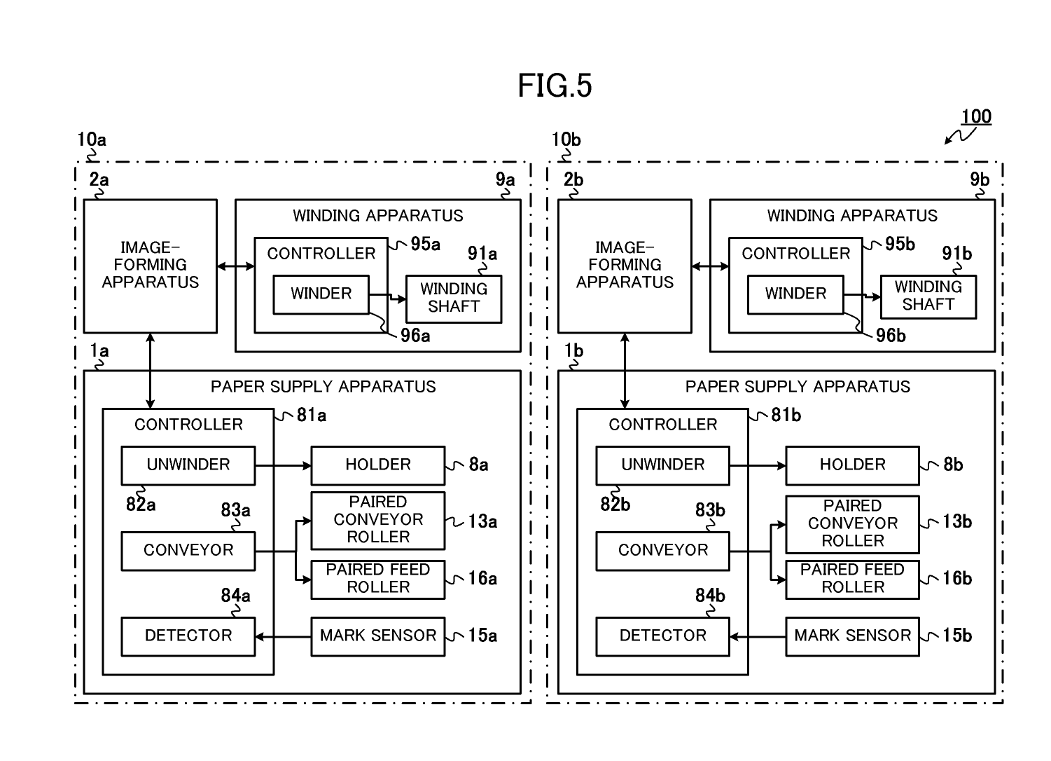

When the first and second print data are sent from the terminal apparatus 60, the paper supply apparatuses 1a and 1b and the winding apparatus 9a and 9b are driven and printing starts. The composition relating to control of the paper supply apparatuses 1a and 1b and the winding apparatuses 9a and 9b is described with reference to FIG. 5.

A controller 81a with which the paper supply apparatus 1a is equipped controls the actions of the paper supply apparatus 1a as a whole through the functions of an unrepresented CPU, RAM, ROM and/or the like. Specifically, the controller 81a functions as an unwinder 82a, conveyor 83a and detector 84a.

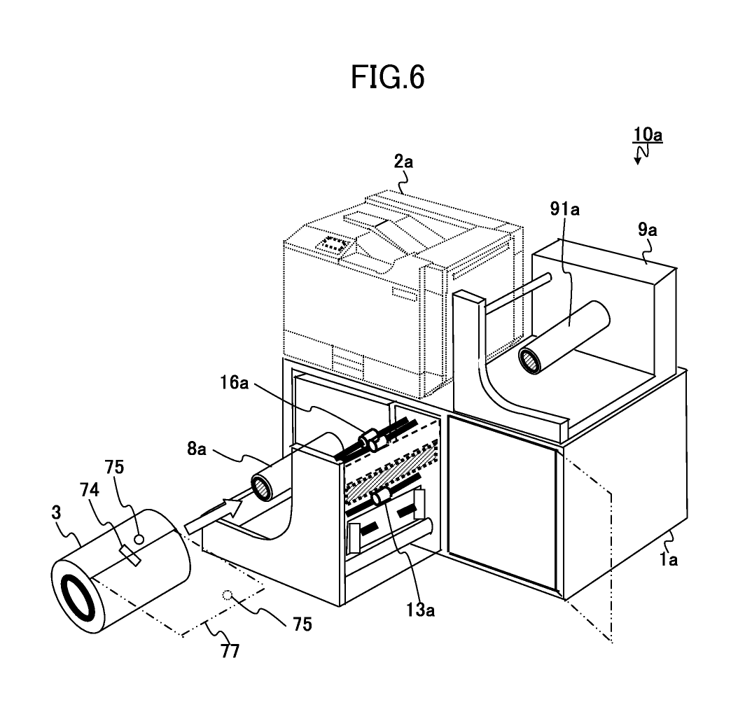

The unwinder 82a functions as a first unwinder and unwinds the roll paper 3 held by the holder 8a. For example as shown in FIG. 6, prior to the start of printing, the user pulls out the holder 8a from the casing of the paper supply apparatus 1a and mounts the pre-printing roll paper 3 the beginning edge 77 of which is anchored by anchor tape 74 on the holder 8a. In this state, when a paper supply request is received from the image-forming apparatus 2a that has received the first print data, the unwinder 82a causes the rotation shaft of the holder 8a to rotate and unwinds the roll paper 3 installed on the holder 8a in order from the beginning edge 77. The conveyor 83a causes the paired conveyor roller 13a and the paired feed roller 16a to be driven and successively conveys the roll paper 3 unwound by the unwinder 82a to the image-forming apparatus 2a.

An original mark 75 is recorded in advance on the roll paper 3. The original mark 75 functions as a reference mark that is a position reference when the image-forming apparatus 2a forms images on the roll paper 3. The original mark 75 is recorded at prescribed intervals (printing pitch). The detector 84a functions as a first detector and detects by means of the mark sensor 15a the original mark 75 recorded on the roll paper 3 conveyed by the conveyor 83a after being unwound by the unwinder 82a.

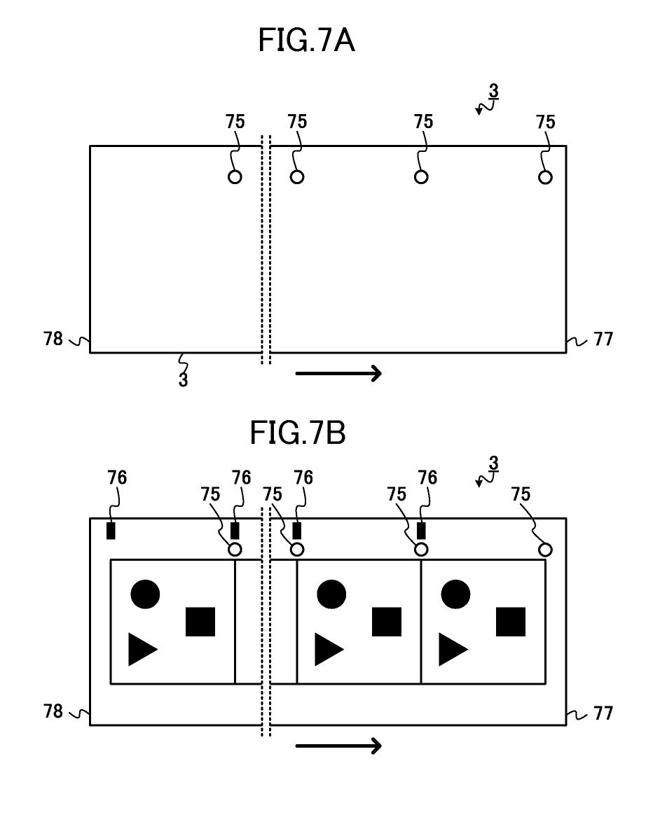

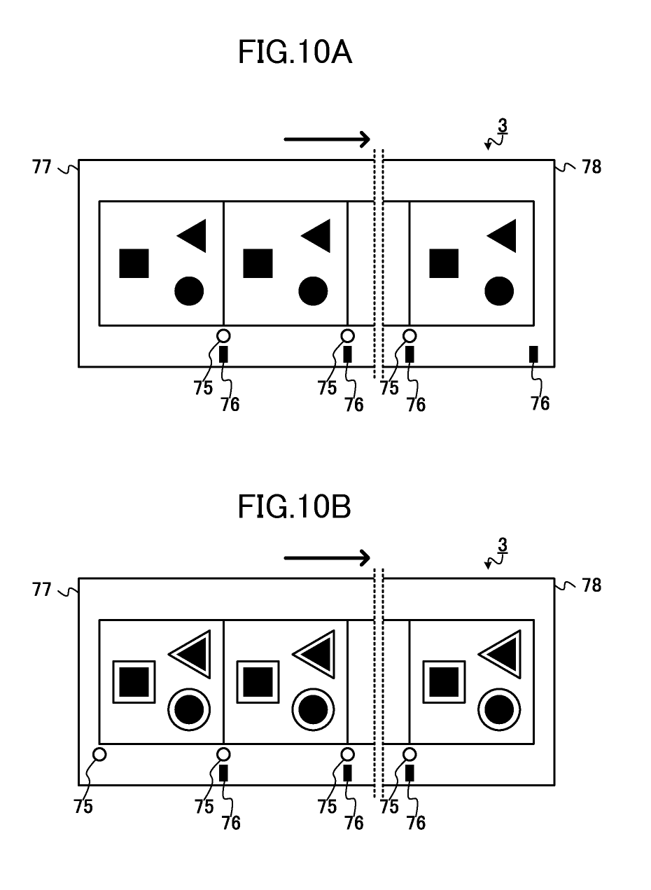

For example, as shown in FIG. 7A, the original mark 75 is recorded at fixed intervals at multiple positions from the beginning edge 77 to a ending edge 78 of the roll paper 3. The intervals are set to a length corresponding to the pitch of the labels in the image data 70 to be output, so that the image-forming apparatus 2a can adjust the position of image formation for each label. To facilitate understanding, FIG. 7A shows a state with the entirety of the roll paper 3 unwound and spread out. In addition, an arrow indicates the conveyance direction of the roll paper 3. The same is true in below-described FIG. 7B, FIG. 10A and FIG. 10B.

The image-forming apparatus 2a (first image-forming unit) forms a first toner image of toner in the four colors of YMCK and transfers the first toner image to the roll paper 3 conveyed by the conveyor 83a, based on the normal color image data 71 sent from the terminal apparatus 60. At this time, the image-forming apparatus 2a transfers the first toner image to the roll paper 3 with the original mark 75 detected by the detector 84a as the position reference, so that the area to which the first toner image is transferred does not shift up-and-down or left-and-right. As a result, an output image for multiple labels for example as shown in FIG. 7B is output to the roll paper 3.

The image-forming apparatus 2a, in addition to the first toner image records a reversal mark 76 on the roll paper 3. The reversal mark 76 functions as a second reference mark that is a position reference when the image-forming apparatus 2b forms images on the roll paper 3, in the below-described special color printing system 10b. As explained below, in the special color printing system 10b, because the roll paper 3 is conveyed in the opposite direction from the direction of conveyance of the normal color printing system 10a, reusing the original mark 75 as the position reference when forming images with the special color printing system 10b is difficult. Consequently, the image-forming apparatus 2a records the reversal mark 76 on the roll paper 3 as a separate standard from the original mark 75. For ease in identification, it is preferable for the reversal mark 76 to be printed with a color of developing agent with which the most density appears among the developing agents in use, such as black and/or the like.

To explain in greater detail, the image-forming apparatus 2a records the reversal mark 76 at multiple positions along the conveyance direction of the roll paper 3 including the ending edge of the area to which the first toner image was transferred. For example as shown in FIG. 7B, the image-forming apparatus 2a records the reversal mark 76 near the original mark 75 with the same spacing as the spacing with which the original mark was recorded, and moreover records the reversal mark 76 near the ending edge 78 of the roll paper 3 where the original mark 75 is not recorded (the ending edge of the area to which the first toner image was transferred). In other words, by recording the reversal mark 76 after the first toner image, it is possible to detect the reversal mark 76 in advance of the timing of transferring the second toner image during reverse printing. The reversal mark 76 thus recorded at a position close to the ending edge 78 becomes a reference for starting image formation in the succeeding special color printing system 10b. The roll paper 3 on which the first toner image and the reversal mark 76 are recorded is fused by the fuser apparatus 40a and ejected to the winding apparatus 9a.

A controller 95a comprising the winding apparatus 9a functions as an unrepresented CPU, RAM, ROM and/or the like and controls the actions of the winding apparatus 9a as a whole. Specifically, the controller 95a functions as a winder 96a, and winds the roll paper 3 to which the image-forming apparatus 2a transferred the first toner image based on the normal color image data 71 around the winding shaft 91a in order from the beginning edge 77 to the ending edge 78 of the roll paper 3.

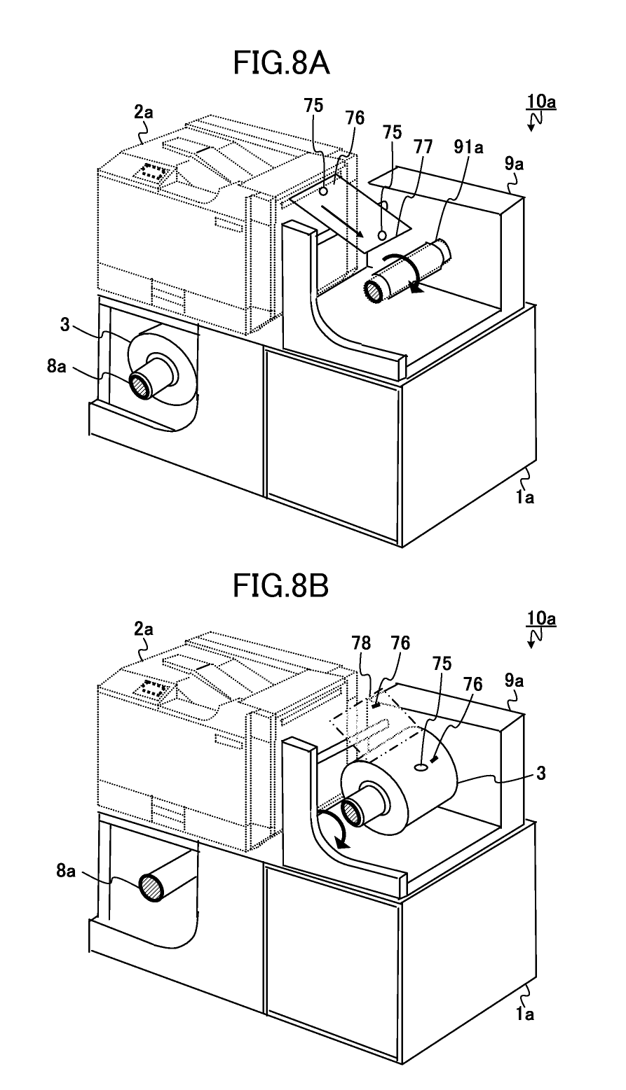

For example as shown in FIG. 8A, the winder 96a, upon receiving a winding request for the roll paper 3 from the image-forming apparatus 2a, causes the winding shaft 91a to rotate and starts winding the roll paper 3 ejected from the image-forming apparatus 2a in order from the beginning edge 77. Furthermore, as shown in FIG. 8B, the winder 96a winds the roll paper 3 ejected from the image-forming apparatus 2a to the ending edge 78. When winding concludes, printing in the normal color printing system 10a concludes. The ending edge 78 of the roll paper 3 that has finished winding is temporarily anchored by the anchor tape 74.

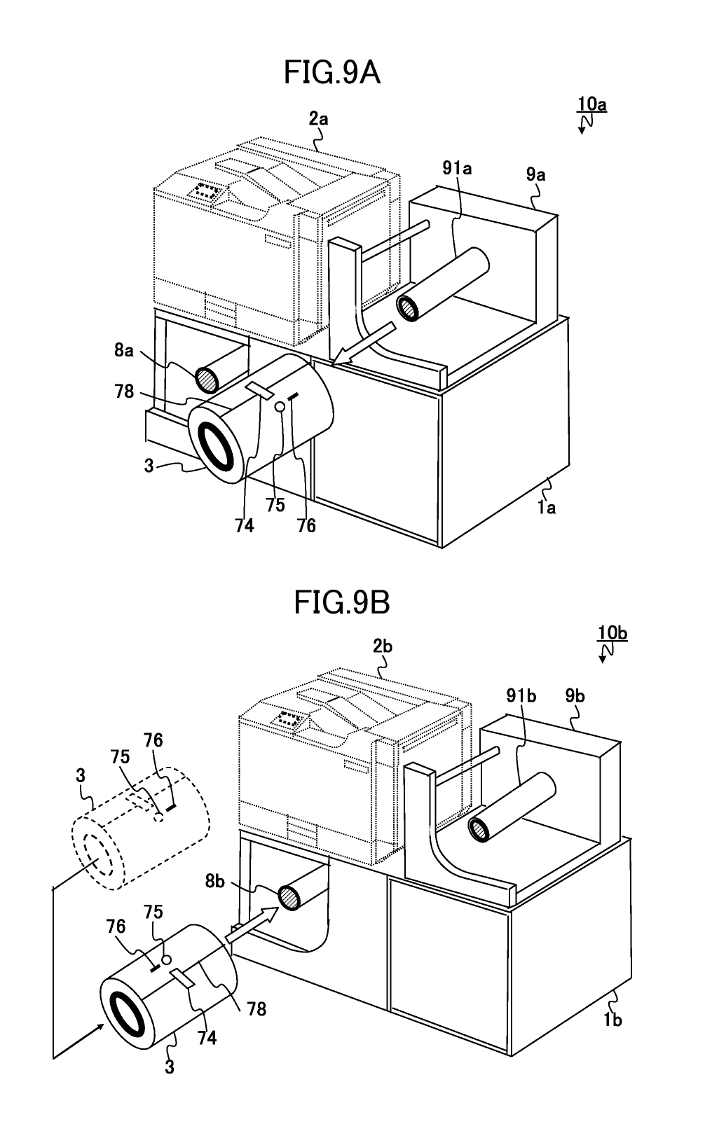

The roll paper 3 wound by the winding apparatus 9a is removed from the winding apparatus 9a as shown in FIG. 9A in order to do an additional printing with special colors, and is mounted on the holder 8b of the paper supply apparatus 1b of the special color printing system 10b. At this time, the user mounts the roll paper 3 on the holder 8b, the roll paper's front-back set reversely in comparison to when the user mounts the roll paper 3 on the paper supply apparatus 1a of the normal color printing system 10a so that a new toner image in special colors can be transferred to the surface to which the first toner image was transferred on the roll paper 3 unwound from the holder 8b. Specifically, as shown in FIG. 9B, the roll paper 3 with the reversal mark 76 positioned to the back of the original mark 75 has reversed so that the reversal mark 76 is positioned to the front of the original mark 75.

That is to say, the roll paper 3 after being wound around the winding apparatus 9a has the beginning edge 77 on the inside and the ending edge 78 on the outside, so compared to the roll paper 3 mounted on the paper supply apparatus 1a of the normal color printing system 10a, the roll paper 3 mounted on the paper supply apparatus 1b of the special color printing system 10b is in a state with left and right (front and back) reversed and beginning and ending (beginning edge and ending edge) reversed.

Returning to FIG. 5, the composition relating to control of the special color printing system 10b is described. The controller 81b with which the paper supply apparatus 1b is equipped controls the actions of the paper supply apparatus 1b as a whole through the functions of an unrepresented CPU, RAM, ROM and/or the like. Specifically, the controller 81b functions as an unwinder 82b, a conveyor 83b and a detector 84b.

The unwinder 82b functions as a second unwinder, causes the rotation shaft of the holder 8b to rotate and unwinds the roll paper 3 attached to the holder 8b in order from the ending edge 78 to the beginning edge 77 of the roll paper 3. The conveyor 83b drives the paired conveyor roller 13b and the paired feed roller 16b and/or the like and successively conveys the roll paper 3 unwound by the unwinder 82b to the image-forming apparatus 2b. Specifically, as shown in FIG. 10A, the conveyor 83b conveys the roll paper 3 to which the first toner image in the normal color printing system 10a was transferred with the ending edge 78 in the lead.

The detector 84b functions as a second detector and detects, through the mark sensor 15b, the reversal mark 76 recorded on the roll paper 3 unwound by the unwinder 82b and conveyed by the conveyor 83b.

The image-forming apparatus 2b (second image-forming unit) forms a second toner image through toner of special colors not included in YMCK, based on the special color image data 73 that is image data in which the image is reversed top-to-bottom and reversed left-to-right from the image data 70 of the printing target. To explain specifically, the image-forming apparatus 2b forms two white toner images by means of the two image-forming parts 21w1 and 21w2 that form images through white toner, and forms toner images in other special colors by means of the image-forming parts 21s1 and 21s2 that form images through other special colors. Furthermore, by superimposing the two white toner images formed and the other special color toner images, a second toner image is formed. Furthermore, the second toner image is transferred to the area to which the first toner image of the roll paper 3 conveyed by the conveyor 83b was transferred.

At this time, the image-forming apparatus 2b transfers the second toner image to the roll paper 3 with the reversal mark 76 detected by the detector 84b as a position reference so that the area to which the second toner image is transferred does not shift to the front or back, or to the left or right. As a result, output images with multiple labels that reproduced the image data 70 of the printing target are output to the roll paper 3, as shown in FIG. 10B. The roll paper 3 on which the second toner image is formed is fused by the fusing apparatus 40b and ejected to the winding apparatus 9.

A controller 95b comprising the winding apparatus 9b controls the actions of the winding apparatus 9b as a whole through the functions of unrepresented CPU, RAM, ROM and/or the like. Specifically, the controller 95b functions as a winder 96b, and winds the roll paper 3 to which the image-forming apparatus 2b has transferred the second toner image based on the special color image data 73 around the winding shaft 91b in order from the ending edge 78 to the beginning edge 77 of the roll paper 3. As a result, the roll paper 3 on which the desired multi-color ink printing was done obtains a wound state with the beginning edge 77 on the outside and the ending edge 78 on the inside, the same as prior to the start of printing.

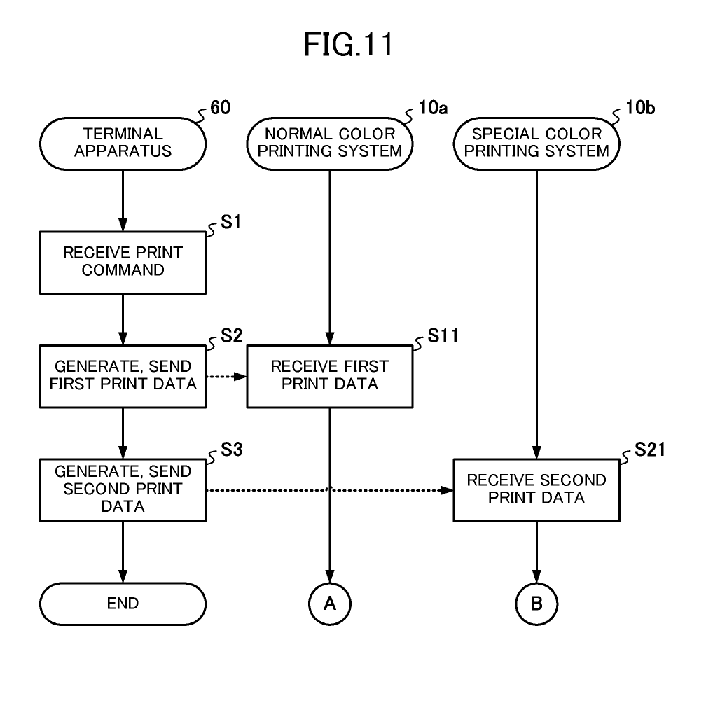

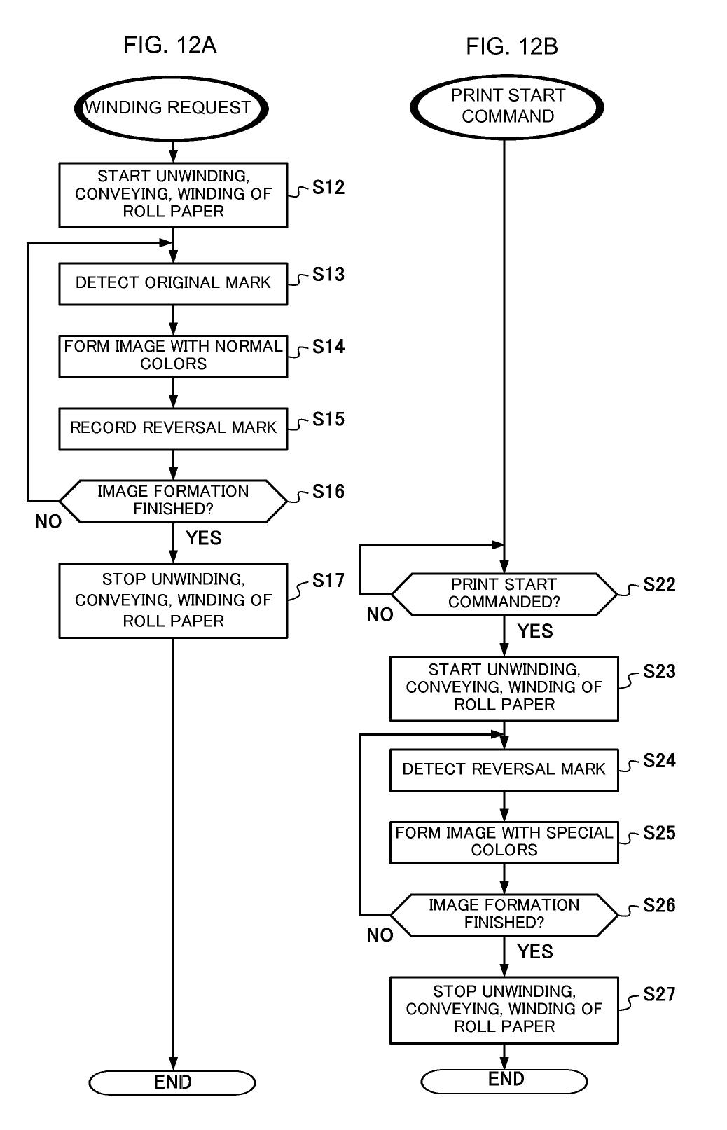

The flow of multi-color printing processes in the above kind of printing system 100 is explained with reference to the flowcharts shown in FIG. 11, FIG. 12A and FIG. 12B.

The multi-color printing processes of the printing system 100 start in a state in which the roll paper 3 prior to printing is attached to the paper supply apparatus 1a in the normal color printing system 10a, and printing preparations have finished, as shown in FIG. 6.

In the terminal apparatus 60, the controller 61, upon receiving a print command from the user via the operation unit 63 for example (step S1), starts the process in the flowchart shown in FIG. 11.

When the print command is received, the controller 61 generates first print data in accordance with the print command and sends the generated first print data to the image-forming apparatus 2a of the normal color printing system 10a (step S2). The first print data includes image data that should be output with the four colors of YMCK in the image data 70 of the printing target, and print conditions, as in the normal color image data 71 shown in FIG. 4B for example.

Along with generating and sending the first print data, the controller 61 generates second print data in accordance with the print command and sends the generated second print data to the image-forming apparatus 2b of the special color printing system 10b (step S3). The second print data is image data that should be output in special colors other than YMCK in the image data 70 of the printing target, as in the special color image data 73 shown in FIG. 4D for example, and includes the image data in which the image is reversed top-to-bottom and is reversed left-to-right from the image data 70 of the printing target, and the print conditions.

In the normal color printing system 10a, the image-forming apparatus 2a receives the first print data sent from the terminal apparatus 60 via the LAN communicator 51a or the USB communicator 52a (step S11). In the special color printing system 10b, the image-forming apparatus 2b receives the second print data sent from the terminal apparatus 60 via the LAN communicator 51b or the USB communicator 52b (step S21). Subsequent processes are explained with reference to the flowchart shown in FIG. 12A and FIG. 12B.

In the normal color printing system 10a, upon receiving the first print data from the terminal apparatus 60, the image-forming apparatus 2a sends a paper supply request to the paper supply apparatus 1a, sends a winding request to the winding apparatus 9a, and begins unwinding, conveying and winding the roll paper 3 (step S12). In the paper supply apparatus 1a that has received the paper supply request, the unwinder 82a unwinds the roll paper 3 held by the holder 8a in order from the beginning edge 77 to the ending edge 78 and supplies the roll paper 3 to the image-forming apparatus 2a via conveyance by the conveyor 83a.

When winding and conveying of the roll paper 3 begins, the detector 84a detects the original mark 75 recorded in advance on the roll paper 3 that is conveyed (step S13). Then, the image-forming apparatus 2a forms image with normal colors (YMCK) on the conveyed roll paper 3 using the position of the detected original mark 75 as a reference (step S14). In addition, the image-forming apparatus 2a records the reversal mark 76 on the roll paper 3 after each image formation (step S15). In the winding apparatus 9a that has received the winding request, the winder 96a successively winds the roll paper 3 on which images have been formed and the reversal mark 76 has been recorded.

While forming images in this manner, the image-forming apparatus 2a determines whether or not the commanded image formation has finished (step S16). When the commanded image formation has not finished (step S16: No), the process returns to step S13. That is to say, the normal color printing system 10a repeats the processes of steps S13-S15 and continues image formation until the commanded image formation finishes.

When the commanded image formation finishes (step S16: Yes), the image formation apparatus 2a sends a paper supply stop request to the paper supply apparatus 1a, sends a winding stop request to the winding apparatus 9a and causes unwinding, conveyance and winding of the roll paper 3 to stop (step S17). Then, printing in the normal color printing system 10a concludes.

When printing in the normal color printing system 10a finishes, the roll paper 3 wound by the winding apparatus 9a is removed from the winding apparatus 9a as shown in FIGS. 9A and 9B and attached with orientation changed to the paper supply apparatus 1b of the special color printing system 10b. When this kind of printing preparation is completed, the user inputs a command for printing with special colors via an operation panel 54b of the image-forming apparatus 2b, for example, and printing in the special color printing system 10b begins.

That is to say, during printing with the normal colors (YMCK) by the normal color printing system 10a, the image-forming apparatus 2b that has received the second print data from the terminal apparatus 60 in the special color printing system 10b determines whether or not the start of printing has been commanded (step S22), and while the start of printing has not been commanded (step S22: No), waits.

When the start of printing is commanded (step S22: Yes), the image-forming apparatus 2b sends a paper supply request to the paper supply apparatus 1b, sends a winding request to the winding apparatus 9b and starts unwinding, conveying and winding of the roll paper 3 (step S23). In the paper supply apparatus 1b that has received the paper supply request, the unwinder 82b unwinds the roll paper 3 held on the holder 8b in order from the ending edge 78 to the beginning edge 77, and supplies the roll paper 3 to the image-forming apparatus 2b via conveyance by the conveyor 83b.

When winding and conveying of the roll paper 3 begins, the detector 84b detects the reversal mark 76 recorded on the conveyed roll paper 3 (step S24). Then, the image-forming apparatus 2b forms image with special colors on the conveyed roll paper 3 using the position of the detected reversal mark 76 as a reference (step S25). In the winding apparatus 9b that has received a winding request, the winder 96b successively winds the roll paper 3 on which images have been formed.

During this kind of image formation the image-forming apparatus 2b determines whether or not the commanded image formation has finished (step S26), and when the commanded image formation has not finished (step S26: No), the process returns to step S24. That is to say, the special color printing system repeats the processes of steps S24-S25 and continues image formation until the commanded image formation finishes,

When the commanded image formation concludes (step S26: Yes), the image-forming apparatus 2b sends a paper supply stop request to the paper supply apparatus 1b, sends a winding stop request to the winding apparatus 9b and stops unwinding, conveying and winding of the roll paper 3 (step S27). Then, printing in the special color printing system 10b and the printing system 100 concludes.

As described above, the printing system 100 according to the first exemplary embodiment achieves multi-color printing with toner in a maximum of eight colors by successively forming images using the two image-forming apparatuses 2a and 2b corresponding to four-color color printing. Since printing with other colors of developing agents in addition to the typical four colors of YMCK is possible, it is possible to form white toner images with two layers superimposed by the two image-forming parts 21w1 and 21w2 forming images with white toner, for example, and it is possible to obtain a sufficient degree of white color even when a white toner image is transferred in a deep base area. In addition, because it is fine to prepare two image-forming apparatuses corresponding to four-color color printing having the same hardware composition, it is not necessary to prepare a large special apparatus corresponding to color printing with five or more colors.

In addition, the printing system 100 according to the first exemplary embodiment, after image formation in the first image-forming apparatus 2a, forms an image with the second image-forming apparatus 2b on the roll paper 3 on which fusing by the fuser apparatus 40a has already been completed. Consequently, the layer depth of the developing agent to be fused by the fuser apparatus does not become too thick and it is possible to prevent deterioration of fusing precision.

Furthermore, the printing system 100 according to the first exemplary embodiment uses the winding apparatus 9a to wind the roll paper 3 on which the image formation by the image-forming apparatus 2a and the fusing have been conducted. Subsequently, the roll paper 3 attached to the second paper supply apparatus 1b forms an image on the roll paper 3 using the image-forming apparatus 2b. That is, the first image-forming apparatus 2b starts to form an image after the roll paper 3, which has been heated upon the fusing in the first image-forming apparatus 2a, sufficiently cools down. Hence, the printing system 100 according to the first exemplary embodiment can ensure an enhanced image quality, as compared to, for example, a configuration in which, with the second image-forming apparatus 2b placed on the top of the first image-forming apparatus 2a, the second image-forming device 2b forms an image immediately after the image formation by the first image-forming apparatus 2a and the fusing of the roll paper 3.

### Second Exemplary Embodiment

Below, a printing system according to a second exemplary embodiment of the present disclosure is described.

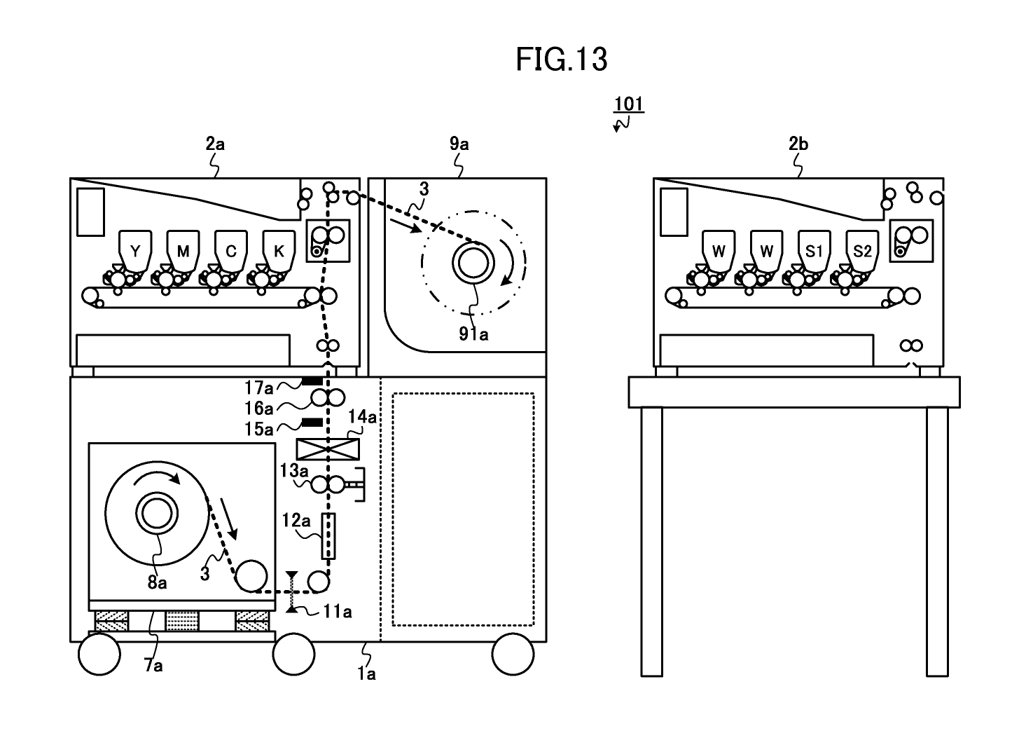

FIG. 13 shows the composition of a printing system according to the second exemplary embodiment. A printing system 101 comprises an image-forming apparatus 2a for forming images using developing agent in the four colors of YMCK, an image-forming apparatus 2b for forming images using developing agent in special colors other than YMCK, a paper supply apparatus 1a and a winding apparatus 9a. That is to say, the printing system 100 according to the above-described first exemplary embodiment was provided with two paper supply apparatuses 1a and 1b and two winding apparatuses 9a and 9b. In contrast, the printing system 101 according to the second exemplary embodiment is not provided with a second paper supply apparatus 1b or a second winding apparatus 9b. In other words, the printing system 101 according to the second exemplary embodiment is composed with the first paper supplier and the second paper supplier, and the first winder and the second winder, as the same unit.

During the first image formation with normal colors (the four colors of YMCK), as shown in FIG. 13 the image-forming apparatus 2a that functions as the first image-forming unit is placed on top of the paper supply apparatus 1a. Furthermore, the paper supply apparatus 1a (first paper supplier), the image-forming apparatus 2a and the winding apparatus 9a (first winder) constitute a system equivalent to the normal color printing system 10a in the first exemplary embodiment.

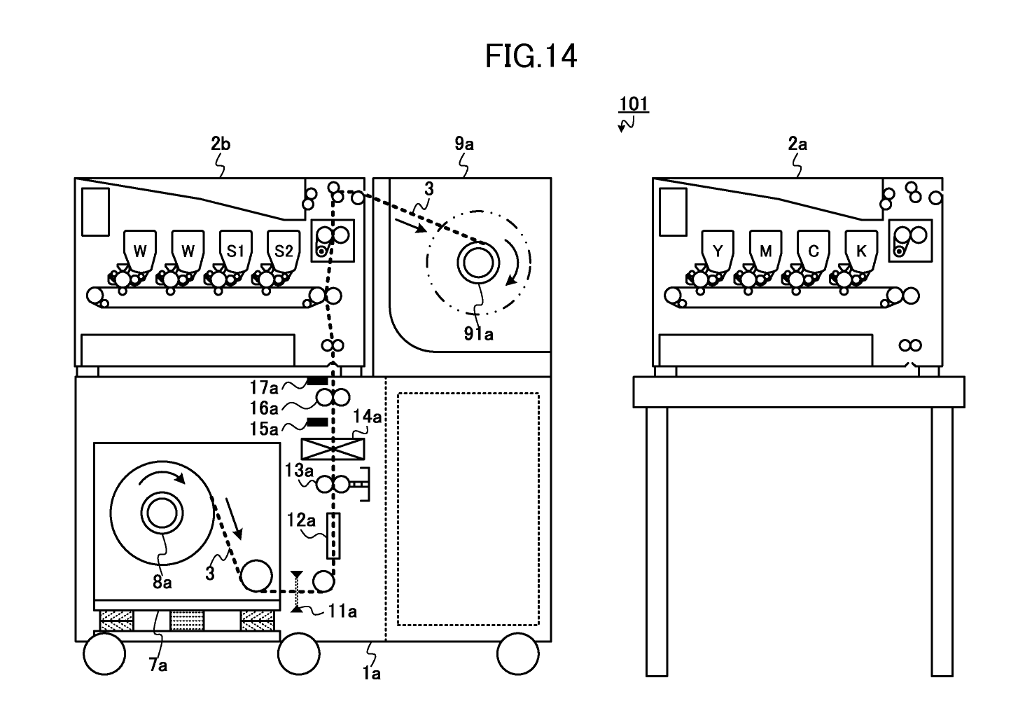

On the other hand, during the second image formation with special colors (white, and/or the like), as shown in FIG. 14 the image-forming apparatus 2b that functions as the second image-forming unit is placed on top of the paper supply apparatus 1a in place of the image-forming apparatus 2a. Furthermore, the paper supply apparatus 1a, the image-forming apparatus 2b and the winding apparatus 9a constitute a system equivalent to the special color printing system 10b in the first exemplary embodiment.

That is to say, the paper supply apparatus 1a in the second exemplary embodiment functions as both of the two paper supply apparatuses 1a and 1b in the first exemplary embodiment. For example, the holder 8a provided in the paper supply apparatus 1a holds the roll paper 3 prior to images being formed by the image-forming apparatus 2a functioning as the first image-forming unit, and also functions as a holder that further holds the roll paper 3 after image formation by the image-forming apparatus 2a and winding by the winding apparatus 9a. The unwinder 82a functions as a first unwinder that unwinds the roll paper 3 held by the holder 8a in order from the beginning edge 77 to the ending edge 78 and supplies the roll paper 3 to the image-forming apparatus 1a, and functions as a second unwinder that unwinds the roll paper 3 held by the holder 8a in order from the ending edge 78 to the beginning edge 77 and supplies the roll paper 3 to the image-forming apparatus 1b. The detector 84a functions as a first detector and a second detector for detecting the original mark 75 recorded in advance on the roll paper 3, and also functions as a second detector for detecting the reversal mark 76 recorded on the roll paper 3 during first image formation.

Similarly, the winding apparatus 9a (first winder) in the second exemplary embodiment functions as both of the winding apparatuses 9a and 9b in the first exemplary embodiment. For example, the winder 96a winds the roll paper 3 on which the image-forming apparatus 1a formed images in order from the beginning edge 77 to the ending edge 78, and winds the roll paper 3 on which the image-forming apparatus 2a formed images in order from the ending edge 78 to the beginning edge 77.

Through this kind of composition, it is possible for the printing system 101 according to the second exemplary embodiment to execute the same high-quality, multi-color printing with fewer constituent elements than the printing system 100 according to the first exemplary embodiment.

### Third Exemplary Embodiment

Below, a printing system according to a third exemplary embodiment of the present disclosure is described.

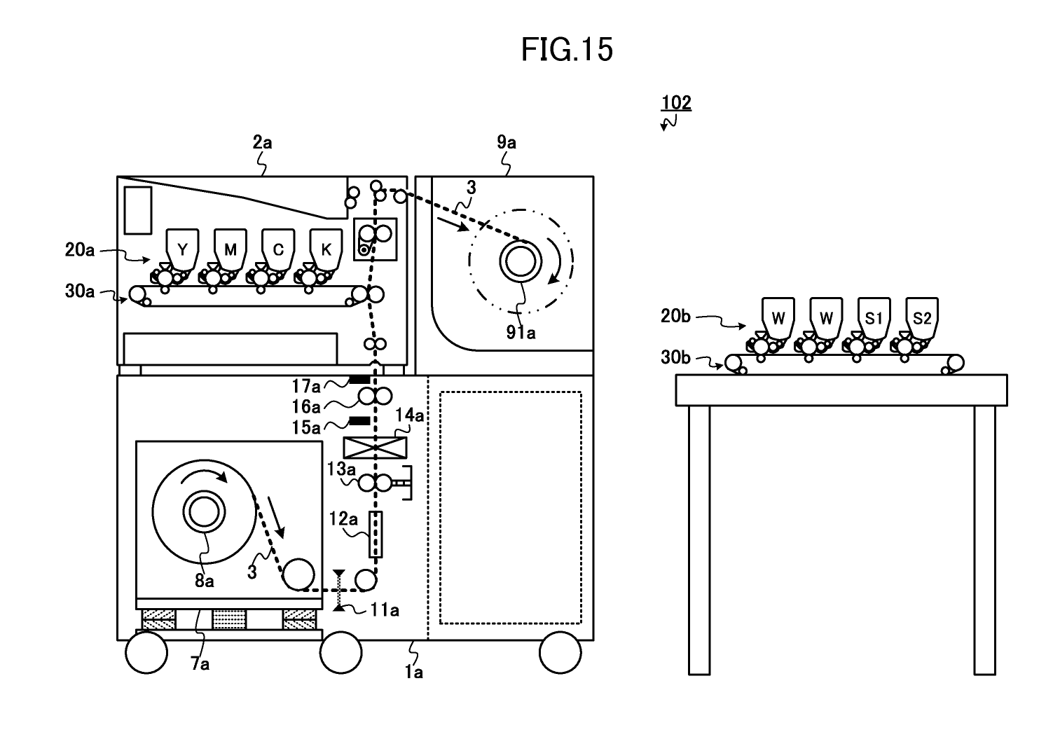

FIG. 15 shows the composition of a printing system according to a third exemplary embodiment. The printing system 102 comprises an image-forming apparatus 2a (first image-forming unit) for forming images using developing agent in the four colors of YMCK, an image-forming unit 20b for forming images using developing agent in special colors other than YMCK, an intermediate transfer belt unit 30b, a paper supply apparatus 1a (first paper supplier) and a winding apparatus 9a (first winder). That is to say, the printing system 101 according to the above-described second exemplary embodiment was provided with two image-forming apparatuses 2a and 2b. In contrast, the printing system 102 according to the third exemplary embodiment is not provided with the second image-forming apparatus 2b. In other words, the printing system 102 according to the third exemplary embodiment comprises, in addition to the first paper supplier and the second paper supplier, and the first winder and the second winder, the first image-forming unit and the second image-forming unit as the same unit.

During the first image formation with normal colors (the four colors of YMCK), as shown in FIG. 15 the image-forming apparatus 2a comprising the intermediate transfer belt unit 30a and the image-forming unit 20a including the image-forming parts 21y, 21m, 21c and 21k for the four colors of YMCK functions as the first image-forming unit.

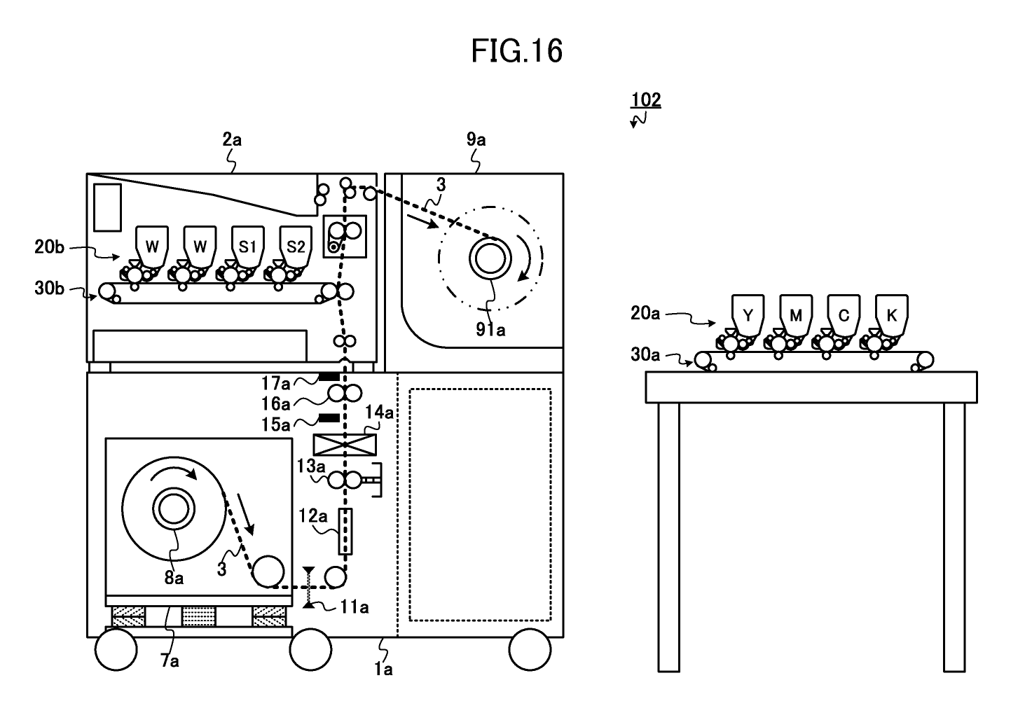

On the other hand, during the second image formation with special colors (white and/or the like), as shown in FIG. 16 the image-forming unit 20a and the intermediate transfer belt unit 30a inside the image-forming unit 2a are respectively replaced by the image-forming unit 20b including image-forming parts 21w1, 21w2, 21s1 and 21s2 for special colors and the intermediate transfer belt unit 30b. Furthermore, the image-forming apparatus 2a (first image-forming unit) comprising the image-forming unit 20b and the intermediate transfer belt unit 30b functions as the second image-forming unit as the same unit physically.

That is to say, with the printing system 102 according to the third exemplary embodiment, one image-forming apparatus 2a removably houses constituent elements including image-forming parts 21, and functions as both the first image-forming unit and the second image-forming unit. As a result, it is possible for the printing system 102 according to the third exemplary embodiment to execute the same high-quality, multi-color printing with fewer constituent elements than the printing system 101 according to the second exemplary embodiment.

(Variations)

The exemplary embodiments of the present disclosure were described above, but the above-described exemplary embodiments are intended to be illustrative and not limiting. That is to say, the exemplary embodiments of the present disclosure have various applications, and all variations should be included within the scope of the present disclosure.

For example, in the above-described exemplary embodiments, the image-forming apparatus 1a functioning as the first image-forming unit formed images using developing agent in normal colors (the four colors of YMCK) and the image-forming apparatus 1b functioning as the second image-forming unit formed images using developing agent in special colors (colors other than YMCK, including white). However, the combinations of colors of developing agent in the first image-forming unit and the second image-forming unit are not limited thereby, as any combination would be fine.

In addition, in the above-described exemplary embodiments, an original mark 75 was recorded in advance as a first reference mark on the roll paper 3. However, in the printing system according to the present disclosure, if it is possible to form the first toner image on the roll paper 3 using another positioning reference, it is possible to use roll paper 3 in which the original mark 75 is not recorded.

In addition, in the above-described exemplary embodiments, the printing systems 100, 101 and 102 executed multi-color printing on the roll paper 3. However, the printing system according to the present disclosure is not limited to a paper medium, that is to say the roll paper 3, and may execute multi-color printing on a printing medium of another material, such as a film recording medium and/or the like.

While it is naturally possible to provide a composition for realizing the functions according to the present disclosure as a printing system prepared in advance, it is also possible through application of programs to cause an existing information processing apparatus and/or the like to function as the printing system according to the present disclosure. That is to say, it is possible for a program for realizing the functional composition of the printing systems 100, 101 and 102 illustrated by the above-described exemplary embodiments to be executed by a CPU and/or the like controlling an existing information processing apparatus and/or the like and through this to cause the apparatus to function as the printing system according to the present disclosure. In addition, it is possible for the printing method according to the present disclosure to be executed using the printing system.

In addition, the method of applying this kind of program is arbitrary. The program can be stored on a computer-readable non-transitory recording medium such as a flexible disk, CD (Compact Disc)-ROM, DVD (Digital Versatile Disc)-ROM, memory card and/or the like. Furthermore, it is possible to overlay the program on carrier waves and to apply such via a communications medium such as the Internet and/or the like. For example, it would be fine to post and distribute the program via a BBS (Bulletin Board System) on a communication network. Furthermore, it would be fine to have a composition such that the above-described processes can be executed by activating this program and similarly executing other application programs under control of the OS (Operating System).

Modifications and variations can be made without departing from broader spirit and scope of the present disclosure. It should be noted that the above embodiments are meant only to be illustrative of those embodiments and are not intended to be limiting the scope of the present disclosure. Accordingly, the scope of the present disclosure should not be determined by the embodiments illustrated, but by the appended claims. It is therefore the intention that the present disclosure be interpreted to include various modifications that are made within the scope of the claims and their equivalents.

What is claimed is:

1. A printing system comprising:
a controller that generates image data and controls printing;
a first paper supplier that unwinds and supplies a printing medium wound around a winding shaft;
a first image-forming unit that forms a first image based on image data, on the printing medium unwound and supplied by the first paper supplier;
a winder that winds the printing medium on which the first image-forming unit formed the first image around a winding shaft in order from a beginning edge to a ending edge of the printing medium;
a second paper supplier that unwinds and supplies the printing medium the winder wound around the winding shaft, in order from the ending edge to the beginning edge of the printing medium; and
a second image-forming unit that forms a second image based on image data in which top and bottom have been reversed and left and right have been reversed in the area where the first image was formed on the printing medium unwound and supplied by the second paper supplier.

2. The printing system according to claim 1, wherein:
the first image-forming unit forms an image through multiple colors of developing agent; and
the second image-forming unit forms images through one or more colors of developing agent including colors not included in the multiple colors.

3. The printing system according to claim 1, wherein:
a first reference mark is recorded in advance on the printing medium;
the printing system further comprises a first detector that detects the first reference mark recorded on the printing medium supplied by the supplier; and
the first image-forming unit forms the first image on the printing medium using the first reference mark detected by the first detector as a position reference.

4. The printing system according to claim 3, wherein:
the first image-forming unit prints a second reference mark on the printing medium supplied by the first paper supplier when forming the first image;
the printing system further comprises a second detector that detects the second reference mark printed on the printing medium supplied by the second paper supplier; and
the second image-forming unit forms the second image in the area where the first image was formed on the printing medium, using the second reference mark detected by the second detector as a position reference.

5. The printing system according to claim 4, wherein the first image-forming unit prints the second reference mark after forming the first image using the first reference mark as a reference.

6. The printing system according to claim 4, wherein the first image-forming unit prints the second reference mark using developing agent in the color with the highest density, from among the developing agents used in forming the first image.

7. The printing system according to claim 2, wherein:
the developing agents in multiple colors includes developing agents in yellow, magenta, cyan and black; and
the developing agent in one or more colors includes, as colors not included in the multiple colors, developing agent of at least one color out of white, gold, silver, transparent colors and special colors for providing fluorescent light or gloss.

8. The printing system according to claim 7, wherein:
the developing agent of one or more colors includes white developing agent as a color not included in the multiple colors; and
the second image-forming unit forms the second image by forming two white images through the white developing agent, based on the image data in which top and bottom have been reversed and left and right have been reversed, and superimposes the two white developing agent images.

9. The printing system according to claim 1, wherein the paper supplier further comprises an incline controller and supplies the printing medium while preventing inclines.

10. The printing system according to claim 9, wherein the incline controller detects the position of the end of the printing medium in the sideways direction and controls incline by controlling the position of the printing medium.

11. The printing system according to claim 1, wherein the first image-forming unit and the second image-forming unit are the same unit.

12. The printing system according to claim 1, wherein the first paper supplier and the second paper supplier are the same unit.

13. The printing system according to claim 1, wherein the first and second paper suppliers respectively comprise a brake at the rotation shaft that unwinds the printing medium.

14. The printing system according to claim 1, wherein the winder comprises a slip unit at the rotation shaft that unwinds the printing medium.

15. The printing system according to claim 1, further comprising a cutter that cuts the printing medium as necessary.

16. The printing system according to claim 1, comprising a housing space that houses the printing medium and consumables.

17. The printing system according to claim 1, further comprising feed sensors in advance of feeding to the first and second image-forming units, and detects the front edge of the printing medium and drives drivers of the first and second image-forming units based on the timing of a signal of the detected front edge.

18. The printing system according to claim 1, further comprising:
a display;
wherein the controller controls the display colors of the print image displayed on the display, and displays the display colors on the display in approximate colors or alternate colors based on the color of the developing agent.

19. A printing method including:
unwinding and supplying a printing medium wound around a winding shaft;
forming a first image on the supplied printing medium based on image data;
winding the printing medium on which the image was formed around a winding shaft in order from a beginning edge to a ending edge of the printing medium;
unwinding and supplying the printing medium wound around the winding shaft in order from the ending edge to the beginning edge of the printing medium; and
forming a second image in the area on which the first image was formed on the printing medium unwound and supplied, based on image data in which top and bottom have been reversed and left and right have been reversed.

20. A non-transitory computer-readable recording medium having stored thereon a program executable by a computer of a device, the program controlling the computer to perform functions comprising:
unwinding a printing medium wound around a winding shaft;
forming a first image on the unwound printing medium based on image data;
winding the printing medium on which the image was formed around a winding shaft in order from a beginning edge to a ending edge of the printing medium;
unwinding the printing medium wound around the winding shaft in order from the ending edge to the beginning edge of the printing medium; and
forming a second image in the area on which the first image was formed on the printing medium unwound and supplied, based on image data in which top and bottom have been reversed and left and right have been reversed.
